(19) United States
(12) Patent Application Publication
(10) Pub. No.: US 2016/0067820 A1
(43) Pub. Date: Mar. 10, 2016

(54) SELECTIVE LASER MELTING SYSTEM

(71) Applicant: UNITED TECHNOLOGIES CORPORATION, Hartford, CT (US)

(72) Inventors: Sergey MIRONETS, Charlotte, NC (US); Agnes KLUCHA, Colchester, CT (US); Wendell V. TWELVES, JR., Glastonbury, CT (US)

(73) Assignee: United Technologies Corporation

(21) Appl. No.: 14/785,899

(22) PCT Filed: Apr. 25, 2014
(86) PCT No.: PCT/US2014/035514

§ 371 Date: Oct. 21, 2015

Related U.S. Application Data
(60) Provisional application No. 61/816,483, filed on Apr. 26, 2013.

(51) Int. Cl. B23K 26/042; B23K 26/342; B23K 26/06; B22F 3/105

(52) U.S. Cl. CPC B23K 26/042; B22F 3/1055; B23K 26/342; B23K 26/0652; B22F 2003/1057; B33Y 10/00

(57) ABSTRACT

An additive manufacturing apparatus comprises a laser beam generator, a build surface spaced apart from the laser beam generator, and first and second adjacent optical elements disposed along a beam travel path between the laser beam generator and the build surface. The first optical element is continuously rotatable about a beam steering axis and the second optical element is continuously rotatable about the beam steering axis independently of the first optical element.

### BACKGROUND

The described subject matter relates generally to the field of additive manufacturing. In particular, the subject matter relates to laser beam steering control in an additive manufacturing environment.

Additive manufacturing refers to a category of manufacturing methods characterized by the fact that the finished part is created by layer-wise construction of a plurality of thin sheets of material. Additive manufacturing may involve applying liquid or powder material to a workstage, then doing some combination of sintering, curing, melting, and/or cutting to create a layer. The process is repeated up to several thousand times to construct the desired finished component or article.

Various types of additive manufacturing are known. Examples include stereo lithography (additively manufacturing objects from layers of a cured photosensitive liquid), electron beam melting (using a powder as feedstock and selectively melting the powder using an electron beam), laser additive manufacturing (using a powder as a feedstock and selectively melting the powder using a laser), and laser object manufacturing (applying thin solid sheets of material over a workstage and using a laser to cut away unwanted portions).

In additive manufacturing, conventional apparatus utilize a galvanometer type scanner to melt powder layers in an X-Y linear orientation. This linear path is broken up into smaller sections, called rastering. This causes discontinuity in the scanning paths, and result in small but significant areas of unmelted powder therebetween, which operates as stress risers in the finished part. Continuous parametric scanning paths have been attempted, but this normally requires substantial and highly precise multi-axis movements of the laser, and in conventional additive manufacturing equipment, the path must still be controlled with Cartesian coordinates.

### SUMMARY

An additive manufacturing apparatus comprises a laser beam generator, a build surface spaced apart from the laser beam generator, and first and second adjacent optical elements disposed along a beam travel path between the laser beam generator and the build surface. The first optical element is rotatable about a beam steering axis and the second optical element is rotatable about the beam steering axis independently of the first optical element.

A method of operating an additive manufacturing apparatus comprises providing raw materials to a build surface disposed along an X-Y plane. A laser beam is generated at a beam starting location spaced apart from the build location. The laser beam is directed through a first optical element and an adjacent second optical element disposed along a beam travel path between the beam starting location and the build location. The first optical element is rotatable about a beam steering axis, and the second optical element is rotatable about the beam steering axis independently of the first optical element. The laser beam is directed from the second optical element to the build surface.

### BRIEF DESCRIPTION OF THE DRAWINGS

FIG. 1 schematically depicts an additive manufacturing apparatus.

FIG. 2 shows a beam steering assembly for the example laser powder deposition machine.

FIG. 3A is a sectional view of the beam steering assembly in a first configuration.

FIG. 3B is a sectional view of the beam steering assembly in a second configuration.

FIG. 3C is a sectional view of the beam steering assembly in a third configuration.

FIG. 4 shows an example scanning path relative to the beam steering axis.

FIG. 5 shows the steps of a method for operating an additive manufacturing apparatus.

### DETAILED DESCRIPTION

A powder bed deposition apparatus can comprise a beam steering assembly including at least one optical element having one surface normal to the X-Y plane and another surface canted relative to the X-Y plane. In certain embodiments, the beam steering assembly can include a Risley prism having a first wedge prism and a second wedge prism each rotatable about a beam steering axis. The beam steering axis can be perpendicular to a working or build surface.

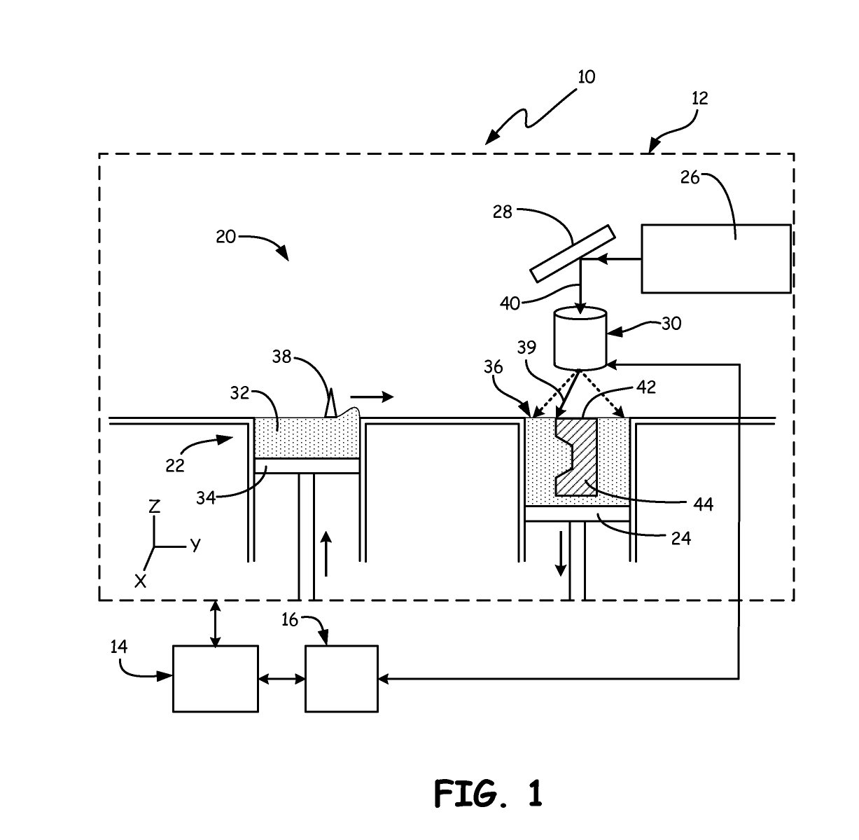

FIG. 1 is a schematic of an additive manufacturing process. Process 10 includes manufacturing chamber 12 containing devices that produce solid freeform objects by additive manufacturing. Embodiments include apparatus that fabricate objects by direct laser sintering (DLS) manufacturing, direct laser melting (DLM) manufacturing, selective laser sintering (SLS) manufacturing, selective laser melting (SLM) manufacturing, laser engineering net shaping (LENS) manufacturing, electron beam melting (EBM) manufacturing, direct metal deposition (DMD) manufacturing, and others known in the art.

Manufacturing is controlled by manufacturing control system 14 and beam steering controller 16. Controllers 14, 16 may be separate or integrated, and can communicate with each other and with device 20. Control systems 14, 16 may allow fully automatic, semi-automatic, or manual control of the additive manufacturing process in manufacturing chamber 12. Manufacturing chamber 12 can be provided with an environment required to produce flaw free solid freeform objects having structural integrity, dimensional accuracy, and required surface finish. In certain embodiments, a protective partial pressure or vacuum atmosphere may be required. This may be under the control of manufacturing control system 14 or a separate environmental controller (not shown).

A non-limiting example embodiment of apparatus 10 is illustrated in FIG. 1 wherein selective laser sintering (SLS) device 20 is shown housed in manufacturing chamber 12. SLS device 20 comprises powder storage chamber 22, build platform 24, energy beam generator 26, minor 28, and beam steering apparatus 30. During operation of SLS device 20, powder 32 is fed upward by piston 34 and is spread over build surface 36 by roller or recoater blade 38. After powder 32 is spread onto build surface 36, energy beam generator 26 is activated to direct a laser or electron beam 39 along beam path 40. Here, beam 39 is directed along path 40 from generator 26 toward minor 28 and into beam steering apparatus 30. As explained in more detail below, beam steering apparatus 30 includes at least one continuously rotatable optical element adapted to receive the oncoming beam 39 and steer it over build surface 36. Steering of beam 39 sinters selective areas of powder 32 to form a single build layer 42 of solid object 44, and to adhere the sintered areas to the underlying platform (or a preceding build layer) according to a computer model of object 44 stored in an STL memory file. Roller or recoater 38 is returned to a starting position, piston 34 advances to expose another layer of powder, and build platform 24 indexes down by one layer thickness and the process repeats for each successive build surface 36 until solid freeform object 44 is completed. SLS device 20 is only one example of solid freeform manufacturing apparatus and is not meant to limit the invention to any single machine known in the art.

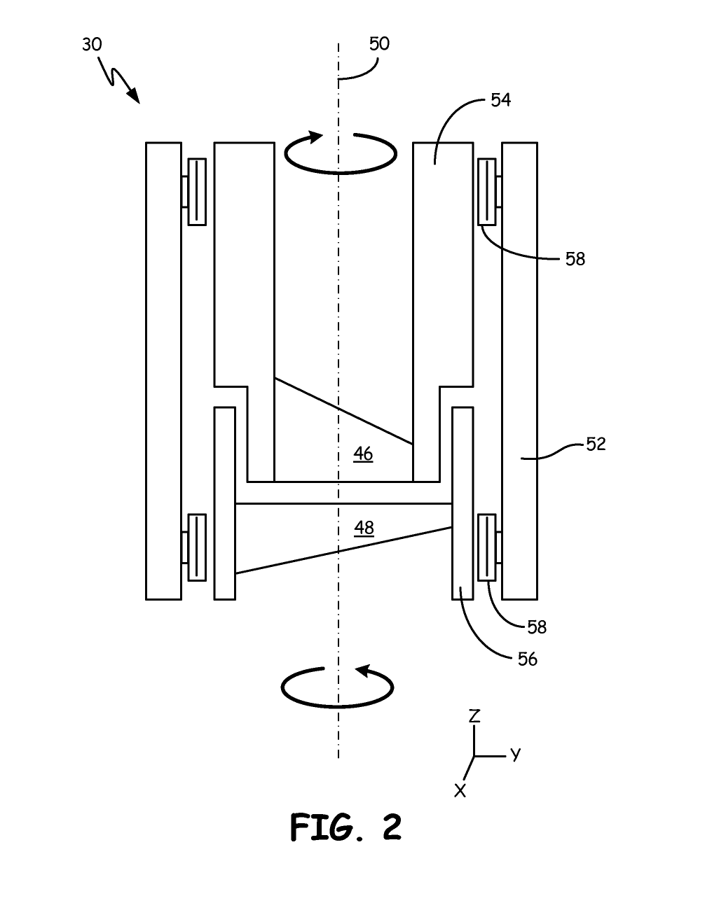

In certain embodiments, minor 28 can be omitted. In certain other embodiments, beam generator 26 and optional mirror(s) 28 can be incorporated into beam steering apparatus 30. In the example of FIG. 1, each build layer 42 is formed and adhered at a build location disposed along the X-Y plane, which is spaced apart from laser beam generator 26. A central axis and/or beam steering axis of beam steering assembly 30 is disposed along beam travel path 40 so that beam 39 is directed along path 40 and through beam steering assembly 30. The continuously rotatable optical element(s) of beam steering assembly 30 (shown in FIG. 2) can be controlled to selectively steer beam 39 in a continuous parametric or other non-linear scanning path over each successive build surface 36. An example of beam steering assembly 30 is shown in subsequent figures.

FIG. 2 shows beam steering assembly 30 with first optical element 46 and second optical element 48 disposed adjacent thereto. Each is continuously rotatable about beam steering axis 50 and retained in housing or case 52. Relative and absolute rotational velocities of optical elements 46, 48 are controlled to form continuous parametric or other nonlinear scanning paths for selective melting of powder 32 (shown in FIG. 1).

Conventional additive manufacturing apparatus utilize a galvanometer type scanner to melt powder layers in a linear or X-Y orientation. This linear path is broken up into smaller sections, called rastering. This causes discontinuity in the scanning paths, and result in small but significant areas of unmelted powder therebetween, which operates as stress risers in the finished part, particularly just under the surface. Continuous parametric scanning paths have been attempted using conventional rastering movements, but this still requires breaking the non-linear path down into miniscule X-Y movements of the laser apparatus, lenses, and/or mirrors. This is because conventional additive manufacturing equipment requires that the steering apparatus be controlled with Cartesian coordinates even when attempting to steer the beam in a non-linear manner.

Here, optical elements 46, 48 are supported to housing 52 and can be driven, for example by dedicated brushed or brushless electric motors which include respective rotors 54, 56, and stators 58. Depending on the exact configuration, rotors 54, 56 can be supported by bearings of any suitable type (not shown).

In certain embodiments, optical elements 46, 48 form a Risley prism. In certain of these embodiments, the second wedge prism can be larger than the first wedge prism. This can be done to ensure the entire beam passes through both optical elements 46, 48 at various deflection angles. Optra, Inc., of Topsfield, Mass., USA, makes several compact Risley prism-based apparatus for use in laser guidance systems, obstacle avoidance, optical communications, and laser machining Such apparatus are not known to have been successfully adapted or implemented in previous additive manufacturing apparatus or processes.

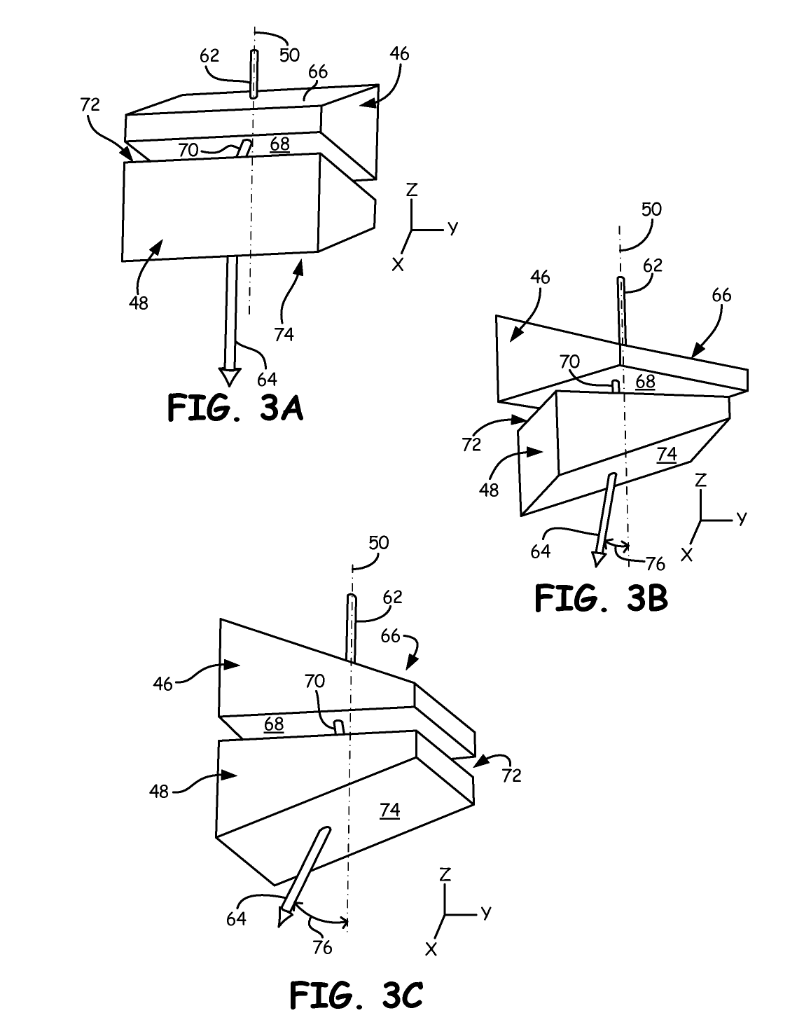

FIGS. 3A-3C each show beam steering angles based on instantaneous positioning of first optical element 46 and second optical element 48. First and second optical elements 46, 48 can be phase-offset from each other to translate incoming beam 62 into outgoing or steered beam 64.

In this example, first optical element 46 is a wedge prism which comprises first beam input surface 66 and first beam output surface 68, each intersected by beam steering axis 50. First beam input surface 66 is canted relative to first beam output surface 68, which can be disposed normal to the X-Y plane. Similarly, second optical element 48 comprises second beam input surface 72 and second beam output surface 74 also each intersected by beam steering axis 50. First beam input surface 66 can be adapted to receive incoming beam 62 by facing the oncoming laser beam (e.g., from laser beam generator 26 and/or minor 28 along beam path 40 shown in FIG. 1. At the same time second beam output surface 74 can face build location 24 also shown in FIG. 1.

First beam input surface 66 and first beam output surface 68 occupy respective first beam input and output planes, each of which depend on the instantaneous rotational position of first optical element 46 about beam steering axis 50. This defines a first beam deflection angle relative to the X-Y plane that is substantially equal to the differential angle between the planes of first beam input surface 66 and first beam output surface 68. When the first beam output plane is substantially parallel to the X-Y plane, the first beam deflection angle is substantially equivalent to the angle of the first beam input plane relative to the X-Y plane, and intermediate beam 70 exits from first beam output surface 68 at a constant radial distance from beam steering axis 50.

Second beam input surface 72 occupies a second beam input plane, which can be substantially parallel to both first beam output surface 68, and to the X-Y plane. Similarly, the second beam input and output planes depend on the instantaneous rotational position of second optical element 48 about beam steering axis 50. This results in a second beam deflection angle relative to the X-Y plane that is substantially equal to the differential angle between the planes of second beam input surface 72 and second beam output surface 74. When the first beam output plane is substantially parallel to the X-Y plane, the first beam deflection angle is substantially equivalent to the angle of the first beam input plane relative to the X-Y plane.

In certain embodiments, second beam output surface 74 can be complementary to first beam input surface 66, and first beam output surface 68 and second beam input surface 72 can both be parallel to the X-Y plane. In these embodiments, and when first and second optical elements 46, 48 are phase-offset by about 180° as shown in FIG. 3A, the first and second deflection angles caused by each respective optical element 46, 48 will generally offset each other. This combination acts effectively as a parallel plate with little or no net deflection of outgoing or steered beam 64 relative to incoming beam 62. This results in an effective beam steering angle of about 0°, with outgoing or steered beam 64 being generally parallel to, or even coincident with, beam steering axis 50.

In FIG. 3B, first and second optical elements 46, 48 are phase-offset by less than 180° resulting in a small deflection and beam steering angle relative to incoming beam 62 and beam steering axis 50. When first and second optical elements 46, 48 are rotated at the same velocity, a relatively small circular scanning path is formed by outgoing or steered beam 64 about beam steering axis 50.

In FIG. 3C, first and second optical elements 46, 48 are not phase-offset and thus both refract light in the same direction. First and second optical elements 46, 48 act as a single prism with twice the deflection angle as the individual elements. This results in maximum deflection or beam steering angle 76 relative to incoming beam 62 and beam steering axis 50. When first and second optical elements 46, 48 are rotated at the same velocity, a large circular scanning path is formed by outgoing or steered beam 64 about beam steering axis 50.

Any point in between those in FIGS. 3A-3C can be achieved by adjusting the relative phase-offset between first and second optical elements 46, 48 to obtain the desired deflection or beam steering angle 76 of steered beam 64. The radius of a circular scanning path can be determined based on the phase-offset and beam steering angle 76 when first and second optical elements 46, 48 are rotated at the same velocity.

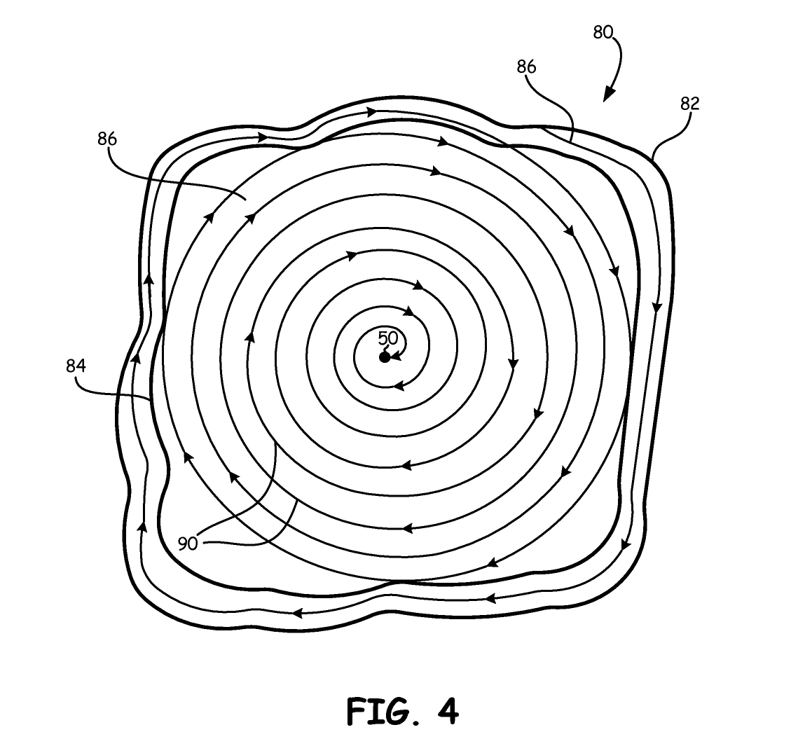

FIG. 4 shows a continuous non-linear scanning path 82 for workpiece build layer 80 relative to beam steering axis 50. To form a continuous non-linear scanning path 82, the rotational velocity of one or both optical elements 46, 48 can be periodically and momentarily adjusted as steered beam 64 (shown in FIGS. 3A-3C) travels over workpiece build layer 80. By slightly slowing or speeding up rotation one or both optical elements 46, 48 the phase-offset angle is changed, as is the resulting beam steering angle 76 relative to beam steering axis 50 (also shown in FIGS. 3A-3C).

In the example of FIG. 4, outgoing beam 64 can be steered in a non-linear scanning path. In addition to relative velocity and phase-offset angle, the absolute rotational velocities can also be adjusted to provide different scanning speeds for different melting solidification needs. Contour exposure parameters about perimeter 82 usually utilize lower beam power and faster scanning speeds, as compared to the power and scanning speeds used in core 84 of each workpiece build layer 80. The lower power and faster speed improves surface finish of perimeter 82.

Scanning path 86 can begin first about perimeter 82 of workpiece build layer 80, then through transition area 88 and into core 84. After one or more scans about perimeter 82, transition area 88 is scanned, then core 84 without breaking the non-linear scanning path. Portion(s) of core 84 can be scanned, for example in connected, substantially concentric circles 90 as seen in FIG. 4.

In traditional X-Y rastering, unsintered powder sometimes remains around transition areas between the perimeter and core. This is because the contour or perimeter scanning is done separately from the core scanning, which is used primarily for better surface finish and dimensional accuracy. Since the issue of unsintered powder can be dealt with using post-processing steps (e.g., consolidation), it has been traditionally preferred to have unsintered powder instead of oversintered material despite additional processing costs.

However, beam steering assembly 30 provides non-linear beam steering path 86 over each workpiece build layer 80, which allows perimeter scanning and core scanning to be integrated into one, and the issue of unsintered powder to be virtually eliminated. This comes from the ability to precisely control rotational velocities of optical elements 46,48, while at the same time managing the absolute rotational velocities, as well as any phase-offset between optical elements 46,48 (shown in FIGS. 2-3C).

FIGS. 1-4 show examples where a single beam is steered by a single beam steering apparatus to a single build platform. In certain embodiments, a plurality of beams (via beam splitter or multiple beam generators) is passed through a corresponding plurality of Risley prisms for synchronous scanning Multiple build platforms can be implemented as well.

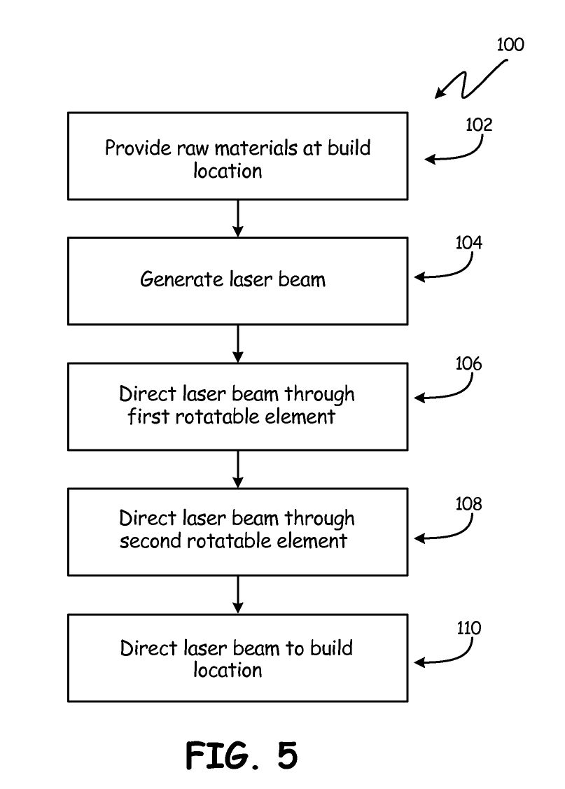

FIG. 5 shows steps of method 100 for operating an additive manufacturing apparatus. Step 102 includes providing raw materials such as powder feedstock to a build location (e.g., a working or build platform). The build location can be disposed along an X-Y plane. As part of step 104, one or more laser beams can be generated at a beam starting location spaced apart from the build location. At step 106, the laser beam is directed through a first optical element disposed along a beam travel path between the beam starting location and the build location. Step 108 includes directing the laser beam through a second optical element disposed along the beam travel path. At step 110, the laser beam then exits the second optical element toward a build location.

As shown in FIG. 2, the first and second optical elements can be continuously rotatable about a beam steering axis. In certain embodiments, the first optical element is a first wedge prism such that directing the laser beam through a first beam input surface, occupying a first beam input plane, defines a first beam input angle relative to the X-Y plane. Directing the laser beam through a first beam output surface, occupying a first beam output plane, defines a first beam output angle relative to the X-Y plane. In certain embodiments, the second optical element is a second wedge prism such that directing the laser beam through a second beam input surface, occupying a second beam input plane, defines a second beam input angle relative to the X-Y plane. Directing the laser beam through a second beam output surface, occupying a second beam output plane, defines a second beam output angle relative to the X-Y plane. In these embodiments, a difference between the second beam input angle and the second beam output angle defines a second beam deflection angle relative to the beam steering axis. A difference between the first and second beam deflection angles can determine the overall beam deflection relative to the beam steering axis.

Rotating the elements by imparting at least one of a first rotational velocity to the first optical element, and a second rotational velocity to the second optical element, results in steering the laser beam selectively over at least a portion of the build location. When a magnitude and direction of the first rotational velocity is equal to that of the second rotational velocity, the resulting portion of the scanning path is substantially circular. The radius of the circular portion of the scanning path is determined based on the phase-offset between the optical elements.

By rotating the first and/or second optical elements (e.g., wedge prisms), this effectively changes the overall beam deflection angle in a continuous fashion. Adjusting the instantaneous phase-offset between the optical elements (see, e.g., FIGS. 3A-3C) while also rotating them causes a resulting portion of the scanning path to be noncircular and nonlinear. A controller manages (relative and absolute) rotational speeds and phase-offset of each optical element so as to define the continuous steering path of each layer. As noted above, the second optical element/wedge prism can be larger than the first optical element/wedge prism to ensure the entire beam width can pass entirely through both elements at all deflection angles.

The steps can be repeated to make an article by additive manufacturing. In this process, occurrence of unmelted powder below the surface is eliminated along with the resulting stress risers in the finished near-net shape component, all without sacrificing surface finish.

### DISCUSSION OF POSSIBLE EMBODIMENTS

The following are non-exclusive descriptions of possible embodiments of the present invention:

An additive manufacturing apparatus comprises a laser beam generator, a build surface spaced apart from the laser beam generator, and first and second adjacent optical elements disposed along a beam travel path between the laser beam generator and the build surface. The first optical element is rotatable about a beam steering axis and the second optical element is rotatable about the beam steering axis independently of the first optical element.

The apparatus of the preceding paragraph can optionally include, additionally and/or alternatively, any one or more of the following features, configurations and/or additional components:

A further embodiment of the foregoing additive manufacturing apparatus, wherein the first optical element comprises a first beam input surface and a first beam output surface each intersected by the beam steering axis.

A further embodiment of any of the foregoing additive manufacturing apparatus, wherein the first beam input surface occupies a first beam input plane defining a first beam input angle relative to the X-Y plane, and the first beam output surface occupies a first beam output plane defining a first beam output angle relative to the X-Y plane.

A further embodiment of any of the foregoing additive manufacturing apparatus, wherein a difference between the first beam input angle and the first beam output angle defines a first beam deflection angle relative to the beam steering axis.

A further embodiment of any of the foregoing additive manufacturing apparatus, wherein the second optical element comprises a second beam input surface and a second beam output surface each intersected by the beam steering axis.

A further embodiment of any of the foregoing additive manufacturing apparatus, wherein the second beam input surface occupies a second beam input plane defining a second beam input angle relative to the X-Y plane, and a second beam output surface occupies a second beam output plane defining a second beam output angle relative to the X-Y plane, a difference between the second beam input angle and the second beam output angle defining a continuously variable second beam deflection angle relative to the beam steering axis.

A further embodiment of any of the foregoing additive manufacturing apparatus, wherein the first beam output surface is parallel to the second beam input surface and the X-Y plane.

A further embodiment of any of the foregoing additive manufacturing apparatus, wherein the first beam input angle is complementary to the second beam output angle.

A further embodiment of any of the foregoing additive manufacturing apparatus, wherein the first optical element comprises a first wedge prism with the input surface of the first optical element adapted to receive an oncoming laser beam from the laser beam apparatus; and the second optical element comprises a second wedge prism with an input surface of the second optical element adjacent to the output surface of the first wedge prism, and an outlet surface of the second optical element facing the build location.

A further embodiment of any of the foregoing additive manufacturing apparatus, wherein the beam steering axis is disposed normal to the X-Y plane.

A further embodiment of any of the foregoing additive manufacturing apparatus, wherein an output of the laser beam generator is aligned with the beam steering axis.

A further embodiment of any of the foregoing additive manufacturing apparatus, further comprising a beam steering controller adapted to rotate the first optical element at a first rotational velocity, rotate the second optical element at a second rotational velocity, and manage a phase-offset between the first and second optical elements to control a beam steering angle.

A further embodiment of any of the foregoing additive manufacturing apparatus, wherein the relative first and second rotational velocities and the phase-offset are periodically adjusted by the controller to defines a non-linear beam steering path.

A method of operating an additive manufacturing apparatus comprises providing raw materials to a build surface disposed along an X-Y plane. A laser beam is generated at a beam starting location spaced apart from the build location. The laser beam is directed through a first optical element and an adjacent second optical element disposed along a beam travel path between the beam starting location and the build location. The first optical element is rotatable about a beam steering axis, and the second optical element is rotatable about the beam steering axis independently of the first optical element. The laser beam is directed from the second optical element to the build surface.

The method of the preceding paragraph can optionally include, additionally and/or alternatively, any one or more of the following features, steps, configurations and/or additional components:

A further embodiment of the foregoing method, further comprising steering the laser beam selectively over at least a portion of the build location.

A further embodiment of any of the foregoing methods, wherein the steering step comprises positioning the first optical element about the beam steering axis to vary a first beam deflection angle.

A further embodiment of any of the foregoing methods, wherein the steering step comprises positioning the second optical element about the beam steering axis to vary a second beam deflection angle.

A further embodiment of any of the foregoing methods, wherein the steering step comprises imparting at least one of: a first rotational velocity to the first optical element and a second rotational velocity to the second optical element; and during the imparting step, controlling a phase offset of the first optical element and the second optical element to define a non-linear beam steering path over the build location relative to the beam steering axis.

A further embodiment of any of the foregoing methods, wherein the first rotational velocity is different from the second rotational velocity.

A further embodiment of any of the foregoing methods, wherein the first optical element comprises a first wedge prism, and the second optical element comprises a second wedge prism larger than the first wedge prism.

Although the present invention has been described with reference to preferred embodiments, workers skilled in the art will recognize that changes may be made in form and detail without departing from the spirit and scope of the invention.

1. An additive manufacturing apparatus comprising:
a laser beam generator;
a working surface including a build location disposed along an X-Y plane and spaced apart from the laser beam generator;
a first optical element disposed along a beam travel path between the laser beam generator and the build location, the first optical element rotatable about a beam steering axis; and
a second optical element disposed adjacent to the first optical element along the beam travel path, the second optical element rotatable about the beam steering axis independently of the first optical element.

2. The additive manufacturing apparatus of claim 1, wherein:
the first optical element comprises a first beam input surface and a first beam output surface each intersected by the beam steering axis.

3. The additive manufacturing apparatus of claim 2, wherein the first beam input surface occupies a first beam input plane defining a first beam input angle relative to the X-Y plane, and the first beam output surface occupies a first beam output plane defining a first beam output angle relative to the X-Y plane.

4. The additive manufacturing apparatus of claim 2, wherein a difference between the first beam input angle and the first beam output angle defines a first beam deflection angle relative to the beam steering axis.

5. The additive manufacturing apparatus of claim 4, wherein the second optical element comprises:
a second beam input surface and a second beam output surface each intersected by the beam steering axis.

6. The additive manufacturing apparatus of claim 5, wherein the second beam input surface occupies a second beam input plane defining a second beam input angle relative to the X-Y plane, and a second beam output surface occupies a second beam output plane defining a second beam output angle relative to the X-Y plan, a difference between the second beam input angle and the second beam output angle defining a continuously variable second beam deflection angle relative to the beam steering axis.

7. The additive manufacturing apparatus of claim 5, wherein the first beam output surface is parallel to the second beam input surface and the X-Y plane.

8. The additive manufacturing apparatus of claim 5, wherein the first beam input angle is complementary to the second beam output angle.

9. The additive manufacturing apparatus of claim 5, wherein:
the first optical element comprises a first wedge prism with the input surface of the first optical element adapted to receive an oncoming laser beam from the laser beam apparatus; and
the second optical element comprises a second wedge prism with an input surface of the second optical element adjacent to the output surface of the first wedge prism, and an outlet surface of the second optical element facing the build location.

10. The additive manufacturing apparatus of claim 1, wherein the beam steering axis is disposed normal to the X-Y plane.

11. The additive manufacturing apparatus of claim 10, wherein an output of the laser beam generator is aligned with the beam steering axis.

12. The additive manufacturing apparatus of claim 1, further comprising:
a beam steering controller adapted to rotate the first optical element at a first rotational velocity, rotate the second optical element at a second rotational velocity, and manage a phase-offset between the first and second optical elements to control a beam steering angle.

13. The additive manufacturing apparatus of claim 12, wherein the relative first and second rotational velocities and the phase-offset are periodically adjusted by the controller to defines a non-linear beam steering path.

14. A method of operating an additive manufacturing apparatus, the method comprising:
providing raw materials to a build location on a working surface, the build location disposed along an X-Y plane;
generating a laser beam at a beam starting location spaced apart from the build location;
directing the laser beam through a first optical element disposed along a beam travel path between the beam starting location and the build location, the first optical element rotatable about a beam steering axis; and
directing the laser beam through a second optical element disposed along the beam travel path, the second optical element rotatable about the beam steering axis independently of the first optical element.

15. The method of claim 14, further comprising:
steering the laser beam selectively over at least a portion of the build location.

16. The method of claim 15, wherein the steering step comprises:
positioning the first optical element about the beam steering axis to vary a first beam deflection angle.

17. The method of claim 15, wherein the steering step comprises:
positioning the second optical element about the beam steering axis to vary a second beam deflection angle.

18. The method of claim 15, wherein the steering step comprises:
imparting at least one of: a first rotational velocity to the first optical element and a second rotational velocity to the second optical element; and
during the imparting step, controlling a phase offset of the first optical element and the second optical element to define a non-linear beam steering path over the build location relative to the beam steering axis.

19. The method of claim 18, wherein the first rotational velocity is different from the second rotational velocity.

20. The method of claim 14, wherein the first optical element comprises a first wedge prism, and the second optical element comprises a second wedge prism larger than the first wedge prism.
